(19) United States
(12) Patent Application Publication
(10) Pub. No.: US 2014/0185212 A1
(43) Pub. Date: Jul. 3, 2014

(54) ELECTRONIC DEVICE WITH INTEGRAL KEYBOARD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: XIAO-YONG MA, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/018,762

(22) Filed: Sep. 5, 2013

(30) Foreign Application Priority Data
Jan. 3, 2013 (CN) 2013100000789

(51) Int. Cl. G06F 1/16

(52) U.S. Cl. CPC G06F 1/1667
USPC 361/679.2

(57) ABSTRACT

An electronic device includes a main body, a keyboard, a supporting member, and a rotating member. The main body includes a display and a receiving portion. The keyboard is rotatably attached to the main body and is received in the receiving portion. The rotating member is rotatably attached to the main body to prevent the keyboard from moving out of the receiving portion. The supporting member supports the electronic device on a surface.

### BACKGROUND

1. Technical Field

The present disclosure relates to electronic devices, and more particularly to an electronic device having an integral keyboard.

2. Description of Related Art

An electronic device, such as an all-in-one electronic device, consists of a host and an integral display. The host is connected to a keyboard by a connecting cable. When the electronic device is moved from a first location to a second location, the connecting cable is detached from the keyboard and the host. However, it is inconvenient to move the keyboard and the host separately. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is an exploded, isometric view of an electronic device in accordance with an embodiment.

FIG. 2 is an enlarged view of a circled portion II of FIG. 1.

FIG. 3 is an isometric view of a main body of the electronic device of FIG. 1.

FIG. 4 is an assembled view of the electronic device of FIG. 1, wherein a keyboard of the electronic device is in an open position.

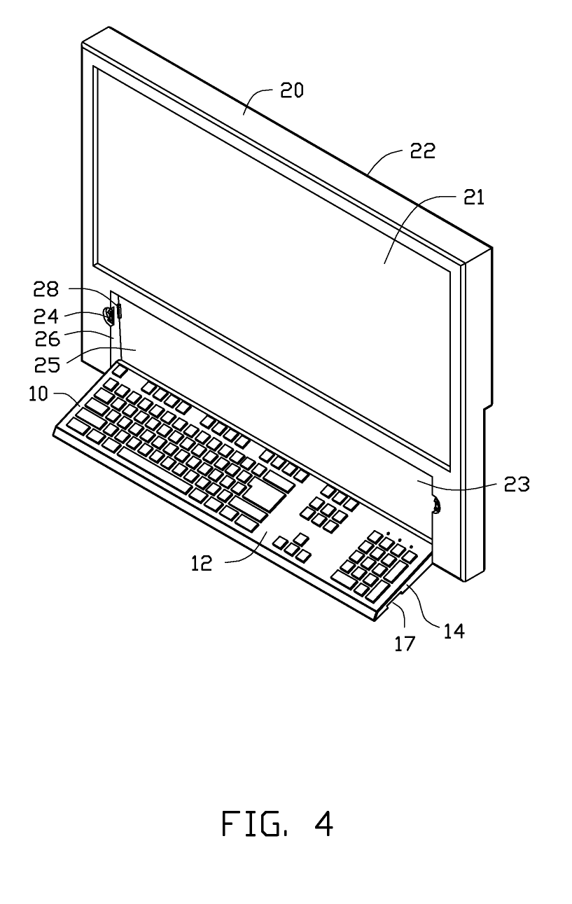

FIG. 5 is similar to FIG. 4, but viewed from a different aspect.

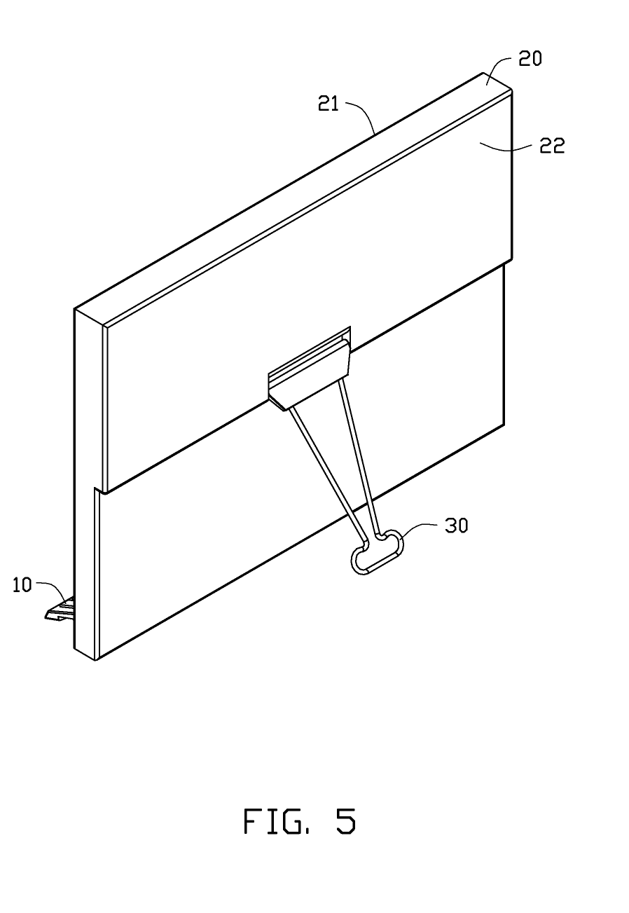

FIG. 6 is an assembled view of the electronic device of FIG. 1, wherein the keyboard of the electronic device is in a closed position.

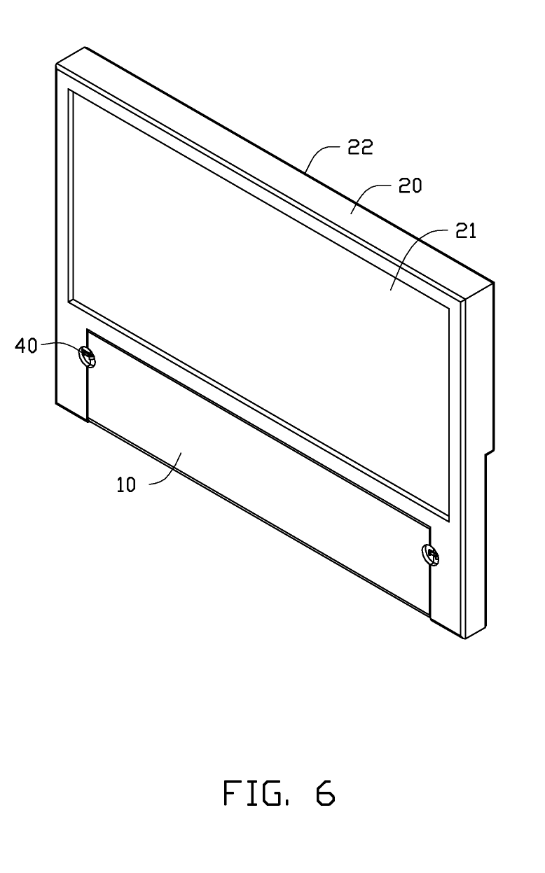

FIG. 7 is similar to FIG. 6, but viewed from a different aspect.

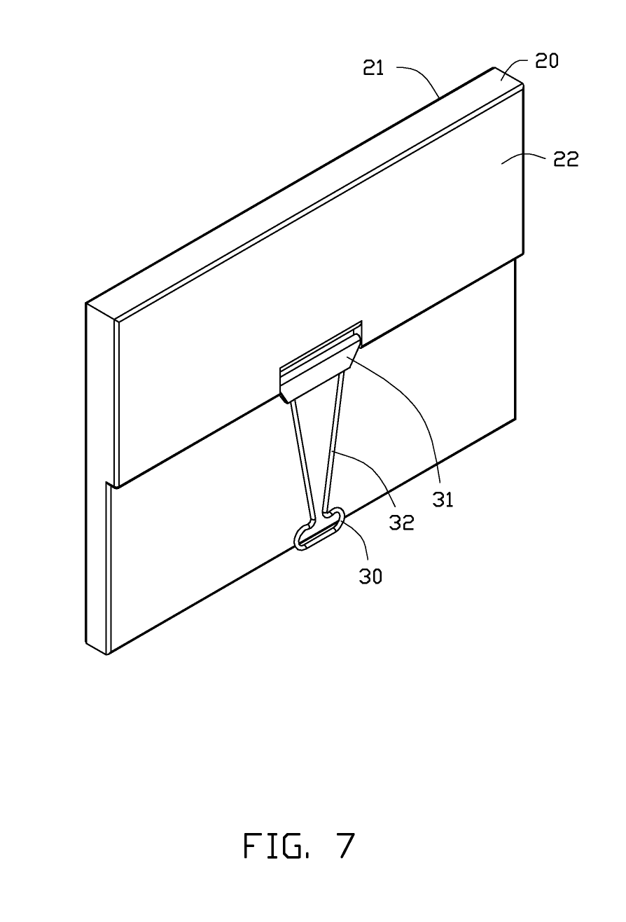

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

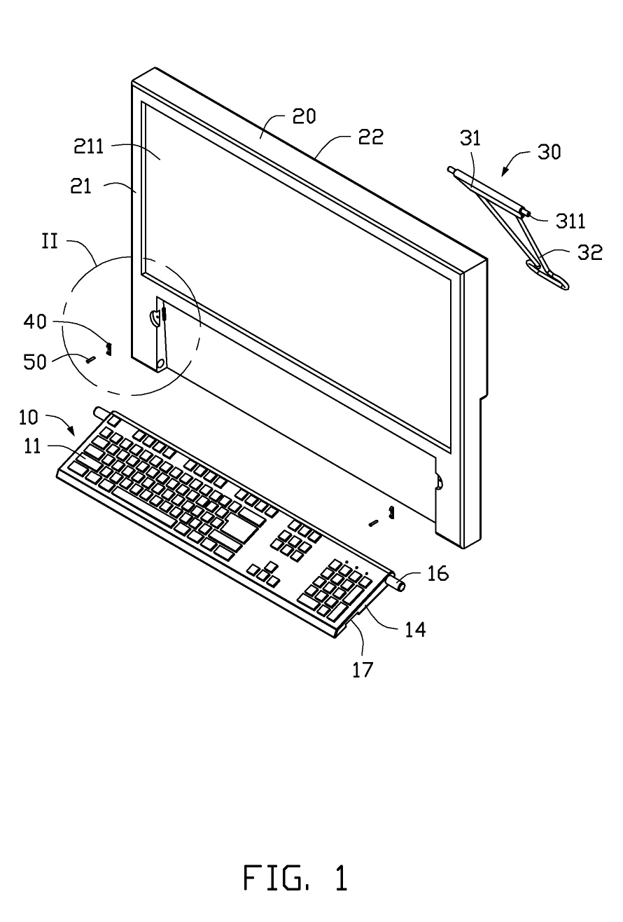

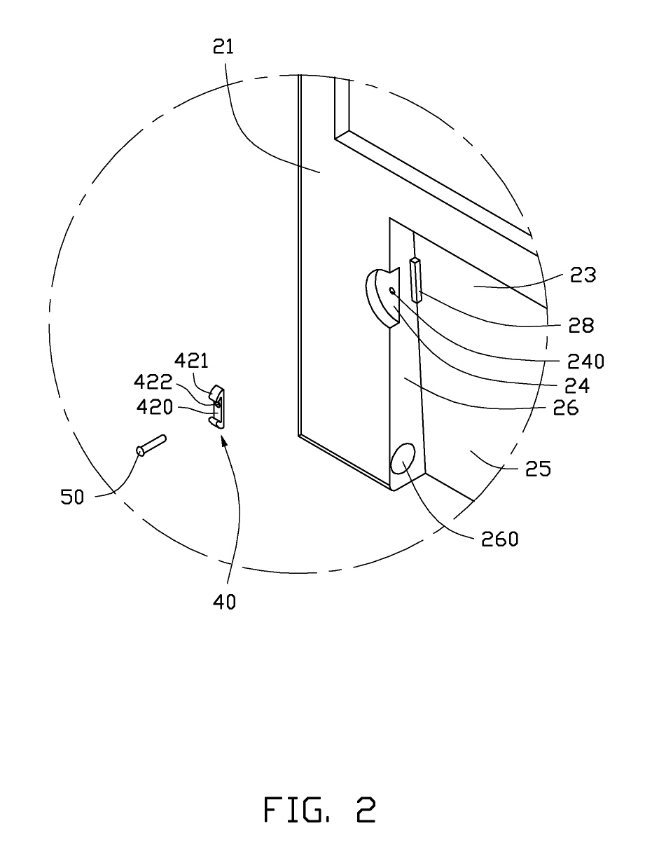

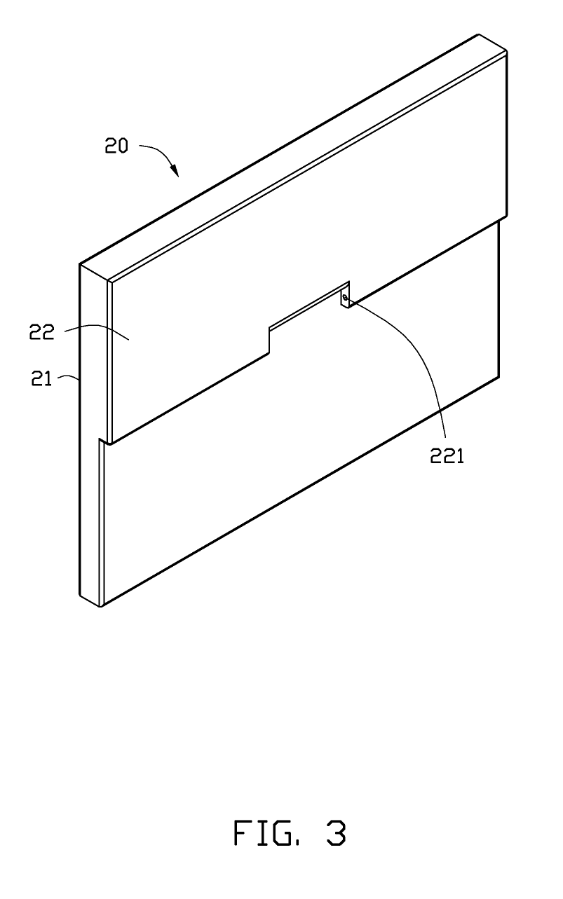

FIGS. 1-3 illustrate an electronic device in accordance with an embodiment. The electronic device comprises a keyboard 10, a main body 20, a supporting member 30, and two rotating members 40. The electronic device is an all-in-one electronic device.

The keyboard 10 comprises a plurality of buttons 11 and opposite side panels 14. A pivoting post 16 extends from each side panel 14, and each side panel 14 defines a first recess 17. The first recess 17 is substantially semi-circular.

The main body 20 comprises a front side 21 and a back side 22 opposite to the front side 21. Two rotating holes 221 are defined in the back side 22. The front side 21 comprises a display 211 (shown in FIG. 1) and a receiving portion 23 located below the display 211. The receiving portion 23 comprises a bottom surface 25 and opposite side surfaces 26 connected to the bottom surface 25. Each side surface 26 is substantially perpendicular to the bottom surface 25, and a size of each side surface 26 is substantially equal to a size of each side panel 14.

A block 28 protrudes from each side surface 26 and adjacent to the bottom surface 25. A second recess 24 is defined in each side surface 26 and the front side 21. Each second recess 24 defines a receiving hole 240. The second recess 24 is substantially semi-circular, and a radius of the second recess 24 is substantially equal to a radius of the first recess 17. A pivoting hole 260 is defined in each side surface 26 for rotating the keyboard 10.

The rotating member 40 comprises a rotating portion 420 and two operating portions 421 extending from opposite sides of the rotating portion 420, respectively. A through hole 422 is defined in the rotating portion 420 and corresponds to the receiving hole 240. A securing member 50, such as a screw, is received in the through hole 422 and the receiving hole 240 to rotatably secure the rotating member 40 to the second recess 24.

The supporting member 30 comprises a mounting portion 31 and a supporting portion 32 connected to the mounting portion 31. Two extending posts 311 extend substantially perpendicularly from the mounting portion 31.

FIGS. 1-3 illustrate that in assembly, the rotating member 40 is received in the second recess 24. The through hole 422 is aligned with the receiving hole 240. The securing member 50 is received in the through hole 422 and the receiving hole 240 to rotatably secure the rotating member 40 to the second recess 24. At this time, the rotating member 40 is fully received in the second recess 24. The two pivoting posts 16 are engaged in the two pivoting holes 260, to rotatably secure the keyboard 10 to the main body 20.

The keyboard 10 is rotated about the pivoting posts 16 and towards the receiving portion 23, until the keyboard 10 is substantially parallel to the bottom surface 25. The block 28 is located between the keyboard 10 and the bottom surface 25 to prevent the keyboard 10 from striking the bottom surface 25. The plurality of buttons 11 face the receiving portion 23. The first recess 17 and the second recess 24 align to form a substantially circular recess. The rotating member 40 is rotated about the securing member 50, until the rotating member 40 is received in the first recess 17. Thus, the rotating member 40 prevents the keyboard 10 from rotating out of the receiving portion 23. The extending posts 311 are received in the two rotating holes 221, to rotatably secure the supporting member 30 to the back side 22 of the main body 20. At this time, the electronic device is in a closed position.

To set the electronic device in an open position, the rotating member 40 is rotated about the securing member 50, until the rotating member 40 disengages from the first recess 17. The keyboard 10 is not prevented by the rotating member 40 from rotating, and is rotated about the pivoting posts 16. Thus, the keyboard 10 is removed from the receiving portion 23 and can rest on a supporting surface, such as a desk. The supporting member 30 is rotated about the two extending posts 311 to support the electronic device on the supporting surface.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device comprising:
a main body; the main body comprising a display and a receiving portion located below the display;
a keyboard rotatably attached to the main body and received in the receiving portion; and
a rotating member rotatably attached to the main body and engaged with the keyboard, for preventing the keyboard from moving out of the receiving portion.

2. The electronic device of claim 1, wherein the rotating member is rotatable about a first axis substantially perpendicular to the main body, and the keyboard is rotatable about a second axis that is substantially perpendicular to the first axis.

3. The electronic device of claim 1, wherein the main body comprises a front side, and when the keyboard is received in the receiving portion, the front side and the keyboard are located on a same plane.

4. The electronic device of claim 1, wherein the receiving portion comprises a bottom surface and a side surface connected to the bottom surface; a block extends from the side surface; and when the keyboard is received in the receiving portion, the block is located between the keyboard and the bottom surface, for preventing the keyboard from abutting the bottom surface.

5. The electronic device of claim 4, wherein the side surface is substantially perpendicular to the bottom surface.

6. The electronic device of claim 4, wherein the side surface defines a pivoting hole, and the keyboard comprises a pivoting post engaged in the pivoting hole.

7. The electronic device of claim 4, wherein the keyboard comprises a first recess, the side surface defines a second recess, the rotating member is rotatably received in the second recess, and the rotating member is rotatable to engage in the first recess.

8. The electronic device of claim 7, wherein a cross-section of the first recess is substantially a semi-circle, a cross-section of the second recess is substantially a semi-circle, and a radius of the first recess is substantially equal to a radius of the second recess.

9. The electronic device of claim 1, further comprising a supporting member, and the supporting member is rotatably attached to the main body.

10. An electronic device comprising:
a main body; the main body comprising a display and a receiving portion located below the display;
a keyboard rotatably attached to the main body and received in the receiving portion; the keyboard comprises a first recess; and
a rotating member attached to the main body;
wherein the rotating member is rotatable relative to the main body to engage in the first recess, for preventing the keyboard from moving out of the receiving portion.

11. The electronic device of claim 10, wherein the rotating member is rotatable about a first axis substantially perpendicular to the main body, and the keyboard is rotatable about a second axis that is substantially perpendicular to the first axis.

12. The electronic device of claim 10, wherein the main body comprises a front side, and when the keyboard is received in the receiving portion, the front side and the keyboard are located on a same plane.

13. The electronic device of claim 10, wherein the receiving portion comprises a bottom surface and a side surface connected to the bottom surface; a block extends from the side surface; and when the keyboard is received in the receiving portion, the block is located between the keyboard and the bottom surface, for preventing the keyboard from abutting the bottom surface.

14. The electronic device of claim 13, wherein the side surface is substantially perpendicular to the bottom surface.

15. The electronic device of claim 13, wherein the side surface defines a pivoting hole, and the keyboard comprises a pivoting post engaged in the pivoting hole.

16. The electronic device of claim 13, wherein the side surface defines a second recess, and the rotating member is rotatably received in the second recess.

17. The electronic device of claim 16, wherein a cross-section of the first recess is substantially a semi-circle, a cross-section of the second recess is substantially a semi-circle, and a radius of the first recess is substantially equal to a radius of the second recess.

18. The electronic device of claim 10, further comprising a supporting member, and the supporting member is rotatably attached to the main body.
